(19) United States
(12) Patent Application Publication
(10) Pub. No.: US 2016/0193632 A1
(43) Pub. Date: Jul. 7, 2016

(54) SYSTEM FOR CLEANING A SURFACE

(71) Applicant: Behzad VAHIDA, Saint Michel Sur Orge (FR)

(72) Inventor: Behzad VAHIDA, SAINT MICHEL SUR ORGE (FR)

(21) Appl. No.: 14/915,722

(22) PCT Filed: Sep. 2, 2014
(86) PCT No.: PCT/EP2014/068637

§ 371 Date: Mar. 1, 2016

(30) Foreign Application Priority Data
Sep. 3, 2013 (FR) 1358440

(51) Int. Cl. B08B 1/00; B08B 13/00

(52) U.S. Cl. CPC B08B 1/005; B08B 13/00

(57) ABSTRACT

A system (4) for cleaning a surface, includes: a surface to be cleaned (10) that extends in perpendicular axial (X) and transverse (Y) directions; a scraping net (12) that is guided with respect to the surface and includes: first filamentary elements (20) which extend in a first direction that is collinear with the axial direction and which are spaced apart from one another in a second direction different from the first direction, second filamentary elements (22) which extend in the second direction and are spaced apart from one another in the first direction, these second elements being fixed to the first elements so as to form a mesh; a moving device (14) configured to move the net in a reciprocating movement in the axial direction and with an amplitude at least equal to the average distance between the second elements.

The invention relates to a system for cleaning a surface.

Some equipment or structures are subject to deposits of various kinds on their external and internal surfaces. These deposits can affect their function or performance, or at least their visual and aesthetic appearance.

There are known cleaning systems to minimize the dirt fouling a surface. “Fouling a surface” is understood here to mean the deposition of foreign matter on the surface, this foreign matter being capable, by its presence on the surface, of affecting the operation or longevity of the surface or of the structure of which said surface is a part. This includes, for example, the formation of ice on surfaces such as aircraft wings or turbine blades, or on cables such as electrical cables, bridge cables, or supporting cables, or drive cables of transportation systems such as aerial tramways. It can also include deposits from biofouling on submerged surfaces such as ship hulls, underwater pipes, or offshore platforms for hydrocarbon extraction. Other types of surface soiling are associated with the deposition of scale or other minerals in tubes, or the formation of hydrates in pipelines that convey hydrocarbons.

It is desirable to clean such a surface frequently or even continuously, because it is easier to clean a recent, thin deposit than an older deposit that is thicker and/or harder to remove. In many cases, it is difficult to clean a surface having excessively thick soiling, and requires cumbersome cleaning means and possibly stopping the use of the surface or the structure of which the surface is a part. Such is the case, for example, with ships, which must be dry-docked to clean the hull. This incurs significant costs.

In general, existing solutions can be classified into two categories:
category 1: remediation;
category 2: prevention.

In the first category, the thickness of the deposit increases until the solution is implemented, while in the second category, the proposed solutions are intended to prevent the deposit from starting to form.

To detach ice and frost deposits from overhead cables, machines have been proposed that move along the entire length of the cables. More recently, solutions using electromagnetic pulses to detach the sleeves of ice have been proposed (WO2013 091651A1). These solutions offer imperfect results, may pose risks to users under the cables, and most are complex to implement. In addition, the equipment of which the cable or cables are a part usually must be taken out of service while cleaning the ice, which results in significant economic losses.

To protect ship hulls against marine biofouling, anti-fouling paints or anti-fouling coatings are often used. These are usually copper-based, and to some extent prevent the attachment of marine organisms. The result is not satisfactory, however, especially when the boat cruising speed is not high enough (below 15 knots).

The use of biocidal coatings has also been proposed, but has gradually been abandoned because of their environmental impact.

Some coatings operate mechanically; silicone-based coatings are used to limit the accretion of marine organisms due to their low coefficient of adhesion. These coatings are high in cost, and here again a top cruising speed of 15 knots is required to obtain satisfactory efficacy.

There are also solutions involving coatings that create certain surface textures to prevent or even discourage marine organisms from attaching to ship hulls or to other surfaces immersed in an ocean environment. These solutions are expensive and the long-term result is not always guaranteed. Lastly, we can also mention the use of ultrasound to repel marine organisms.

Also known is the device described in patent application WO 2013/006023 A1. This device allows cleaning the pillars of an oil platform by means of wave-driven rollers that crush marine biofouling formed on these pillars.

This device has drawbacks. In particular, the cleaned surface is limited to areas at sea level. In addition, this device only partially cleans the circumference of the pillar. The shape that this surface can have is also limited to cylindrical surfaces. This device can therefore not be used effectively on all surfaces.

For tubes and pipelines, the existing solutions consist of using very expensive special coatings, or else periodic cleaning by special machines circulating inside them. A shutdown is again necessary, which has an economic impact. In addition, the operating performance deteriorates over time prior to the cleaning.

The invention aims to solve one or more of the disadvantages listed above.

The invention thus relates to a system for cleaning a surface according to claim 1.

The embodiments of the invention may comprise one or more of the characteristics of claims 2 to 25.

Thus, the invention has a much better operating performance in comparison to remediation solutions (category 1). By enabling an almost continuous cleaning of the surfaces during operation, not only is the performance of the equipment or structure maintained over time, but the shutdowns required to implement the existing methods are avoided.

In addition, the almost continuous cleaning ensures much better results than cleaning occurring at timed intervals.

Moreover, the proposed solution is simple and robust in design, providing superior reliability of operation over time in comparison to existing solutions.

Finally, the costs of manufacture, installation, operation, maintenance, and removal of the proposed system are much lower than those of existing preventive solutions (category 2). Although theoretically inhibiting deposits from beginning to form on surfaces, those high-tech solutions are not yet mature and in general remain costly to implement and maintain.

Other features and advantages of the invention will become apparent from the description which is given below, as an indication and in no way limiting, with reference to the accompanying drawings, in which:

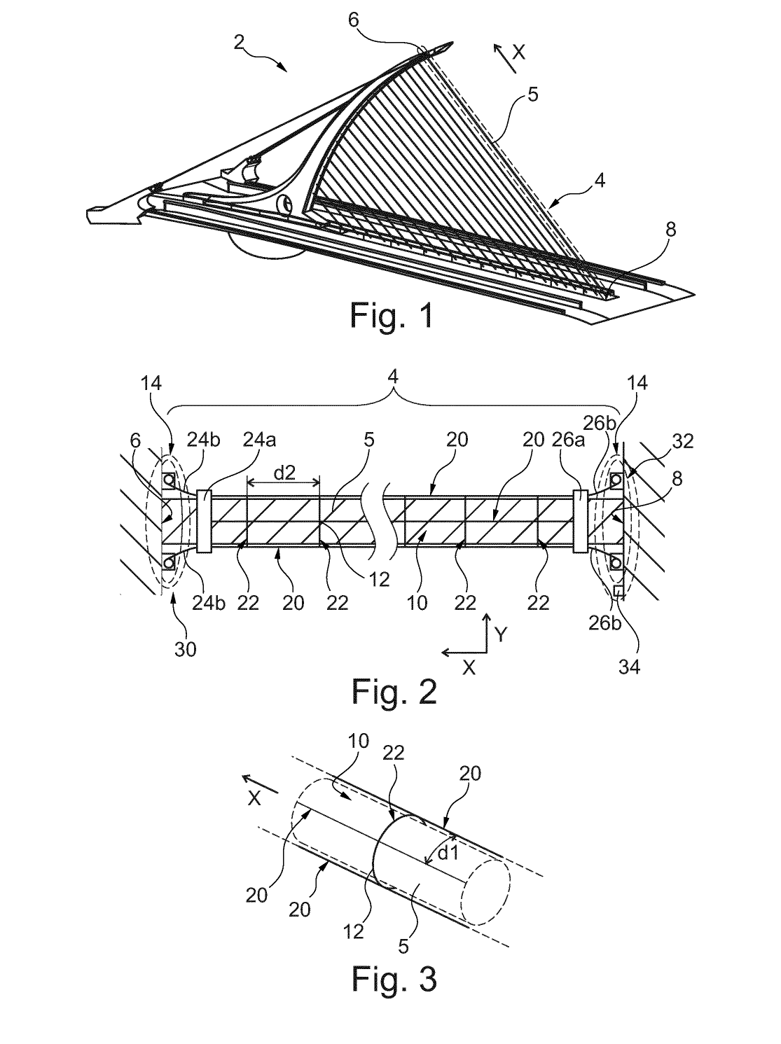

FIG. 1 shows a cable-stayed bridge with a stay cable equipped with a system for cleaning a surface;

FIG. 2 schematically illustrates, in a side profile view, the stay cable having the system for cleaning a surface of FIG. 1;

FIG. 3 is a detailed perspective view of a portion of the system for cleaning a surface of FIG. 2;

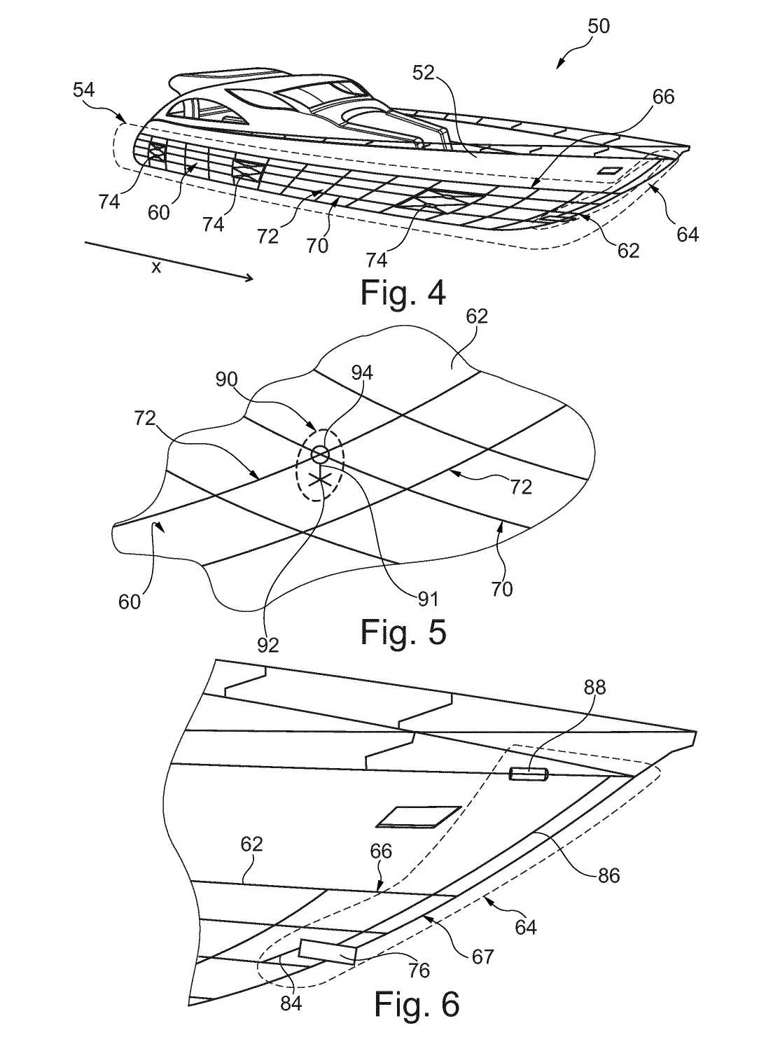

FIG. 4 schematically illustrates a vessel comprising another embodiment of the system of FIGS. 1 to 3 for cleaning the hull of the boat;

FIG. 5 schematically illustrates another embodiment of a net of the cleaning system of FIG. 4;

FIG. 6 schematically illustrates a device for moving the cleaning system of FIG. 2;

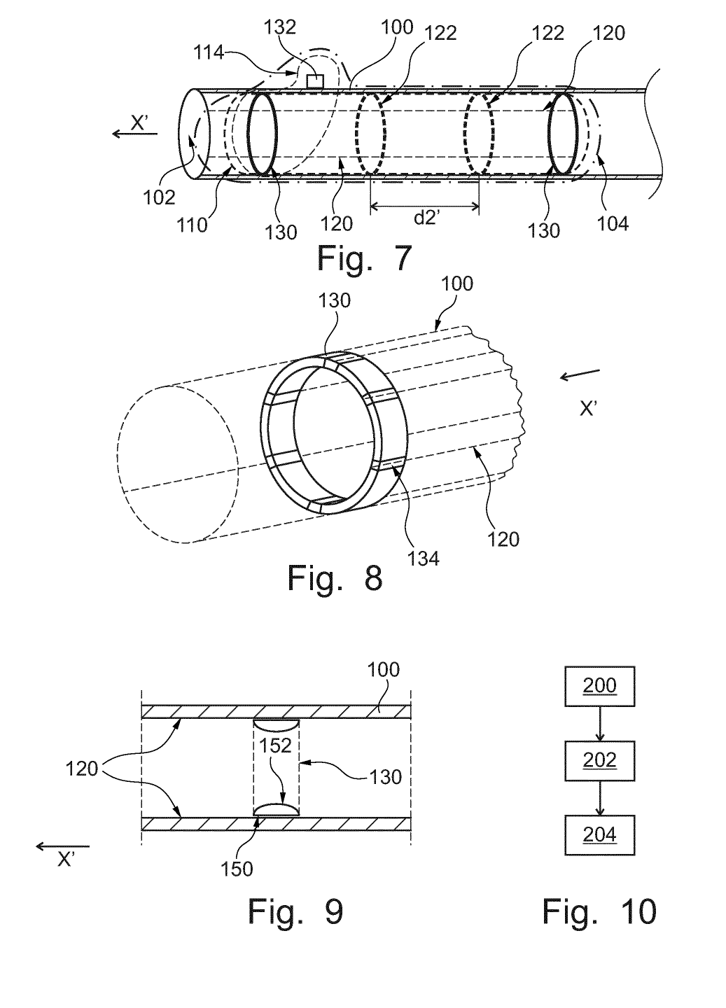

FIG. 7 schematically illustrates a side view of a pipe in which the interior comprises another embodiment of the system of FIGS. 1 to 3 for cleaning the surface of the inner wall of the pipe;

FIG. 8 schematically illustrates an actuator of the system of FIG. 5;

FIG. 9 schematically illustrates a sectional view of an element of the system of FIG. 5.

FIG. 10 is a flowchart of a method for cleaning a surface by means of a cleaning system among the systems of FIGS. 1 to 9.

FIG. 1 shows a cable-stayed bridge 2. The bridge 2 here comprises a plurality of cables, their respective outer surfaces needing to be cleaned in order to reduce the formation of ice or frost on the cables during winter weather conditions. For this purpose, each of these cables is fitted with a system for cleaning a surface. For simplicity, only the system 4 for cleaning a surface of a cable 5 will be described in detail. This cable 5 (guy wire) has a uniform cylindrical shape and extends longitudinally in a substantially straight line between its two ends 6 and 8. Cable 5 is subjected to tensile stress.

FIGS. 2 and 3 show the system 4 in more detail. This system 4 comprises:
a surface 10 to be cleaned,
a net 12 for scraping the surface 10, and
a device 14 for moving the scraping net 12, configured to move the net 12.

The surface 10 extends in axial and transverse directions that are perpendicular to each other. Here, the surface 10 is the outer face of the cable 5. The axial direction is direction X here. The surface 10 thus has an outer face that is cylindrical in shape. The transverse direction here forms an arc of the same curvature as the surface 10 and is denoted Y.

The net 12 extends over the surface 10. The net 12 is able to move relative to the surface 10 and is guided relative to the surface 10 in direction X, for example by the surface 10 itself. The net 12 comprises:
filamentary elements 20, and
filamentary elements 22 pressed against the surface 10 and fixed to elements 20 to form a mesh.

Elements 20 extend in a first direction collinear to direction X and are spaced apart from each other in a second direction that is different from the first direction. The elements 20 are identical here and have the same length.

Elements 22 are in particular suitable for cleaning the surface 10 by scraping when elements 22 are moved in direction X relative to the surface 10. Elements 22 each have a shape complementary to that of the surface 10. Elements 22 extend along the second direction and are spaced apart from each other along the first direction.

Here, the first and second directions respectively correspond to directions X and Y. Here, each element 22 extends along direction Y and thus has a non-zero curvature. Each element 22 here therefore has a circular shape.

Because of this spatial configuration of the net 12, the elements 22 mainly act as scraping elements, while the elements 20 mainly act as tensioning the elements 22. The surface 10 is thus cleaned by scraping it with the elements 22.

In this example, the mesh of the net 12 also has a homogeneous distribution and regular spacing between elements 20 and elements 22. The distance between two elements 20, measured along direction Y and along element 22, is denoted d1. Likewise, d2 denotes the distance between two elements 22, measured in direction X. Here, distance d1 is selected according to the dimensions of the cable 5 and in particular of the diameter D of the cable 5. Distance d1 is chosen here so that the number N of elements 20 of the net 12 is between two and twenty. Preferably, this number N is between four and eight. Here, the cable (guy wire) has a length of between 20 m and several hundred meters and has a diameter greater than or equal to 10 cm or 20 cm or 50 cm. Distance d2 and the number M of elements 22 are also chosen based on the dimensions of the cable 5. Distance d2 is, for example, between D/2 and 10*D. Preferably, this distance is between 2*D and 5*D. Thus, for a cable 20 cm in diameter, distance d2 is between 40 cm and 1 m.

The net 12 is configured to withstand tensile loads exceeding 10 kN. In this example, the net 12 is made of metal. Elements 20 and 22 are steel cables here, such as single-strand cables. The diameter of these cables here is greater than or equal to 2 mm or 5 mm.

The radius of curvature of each element 22 when at rest is preferably less than the radius of curvature of the surface 10. An element 22 is said to be at rest when it is not pressed against a surface such as the surface 10. Here, in addition, each element 22 is elastically deformed when it is pressed against the surface 10. The pressure against the surface 10 is thus increased, which improves cleaning efficiency. The pressure is optimized, however, to ensure proper guidance of the net over the surface while minimizing resistance to the movement of the net over the surface to be cleaned.

Due to the use of a mesh, the scraping surface area is much smaller than the surface area to be cleaned, which reduces the forces required for the device 14 to drive or advance the net 12. For example, the size of the areas of the surface 10 which are in contact with the elements 22 is less than 3% or even 1% of the total surface area of the surface 10.

Advantageously, the total surface area of the orthogonal projection of the net 12 onto the surface 10 is less than 5% or 3% or 1% of the total area of the surface 10, this projection being done in a direction normal to the surface 10.

In addition, traction is facilitated by the lightness of the net 12. The net 12 has a reduced weight compared to that of the cable 5 and compared to known cleaning structures. This reduces the power that needs to be provided by the actuator 14.

The use of a mesh also limits the tendency of deposits to accumulate on the net.

Advantageously, the outer face portion of the elements 22 that is in contact with the surface 10 is covered with a protective coating. The function of this protective coating is to reduce abrasion of the element 22 or of the surface 10 without limiting the ability of the elements 22 to scrape the surface 10. This protective coating comprises, for example, teflon or high density polyethylene.

The net 12 extends between ends referred to as axial and here are connected to the device 14. For example, the ends here are each formed by a rigid metal ring 24a, 26a encircling the cable 5 and adapted to move relative to this cable 5 along direction X. The ends of each of the elements 20 are attached to these axial ends. These rings are here respectively attached to the device 14 by drive cables 24b, 26b. The size of these rings 24a, 26a is small relative to the length of the cable. The width of these rings 24a, 26a, measured in direction X, here is less than 20 cm.

In case of equipment or lines hanging from the cable (guy wire), such as dynamic dampers or struts for example, the net 12 has dedicated openings in line with these protrusions. Thus, the net 12 can travel back and forth without impediment, as the dedicated openings move around the protrusions while encircling them.

The device 14 is configured to move the net 12 in a reciprocating movement along direction X and with an amplitude of movement at least equal to the average distance between the second filamentary elements.

Here, the device 14 is configured to move the net periodically along direction X by a distance d that is greater than or equal to distance d2. Advantageously, distance d is less than or equal to 3 times distance d2.

Thus, the entire surface 10 is scraped by the various elements 22 by moving the net 12 by an amplitude d which is small relative to the overall dimensions of the surface 10. This allows reducing the power and/or dimensions of the device 14.

The device 14 here comprises:
two actuators 30,32 respectively attached to the axial ends 24, 26 of the net 8,
drive cables 24b and 26b,
a control module 34.

Each of these actuators 30, 32 is configured to exert traction along direction X in a particular direction of movement, the respective directions of movement of these actuators 30 and 32 being opposed.

The module 34 is programmed to actuate, successively and alternately, one or the other of the two actuators 30 and 32. For example, the module 34 is programmed to:
send a control signal to actuator 30 so that actuator 30 moves the net 12 by a distance d in a first direction of movement along direction X;
then, when the net 12 has been moved by distance d in this first direction, stopping actuator 30 then sending a control signal to actuator 32 so that the actuator 32 moves the net 12 by a distance d along direction X and in the direction of movement opposite the first direction.

The frequency of the movements is programmed into the module 34 such that the thickness of the ice that forms on the cable between two successive passages is small. In this manner, the amount of energy consumed by the cleaning device is optimized and the stresses induced in the device remain within acceptable values.

Actuators 30 and 32 are identical here. These actuators 30 and 32 here each comprise a winch secured without any degree of freedom to the surface 10. Here, the actuators 30, 32 are placed respectively at both ends of the cable 5 (guy wire). The winch of each of the actuators 30 and 32 here respectively actuates the drive cables 24b and 26b.

Advantageously, the system 4 is removable, in other words it can be disassembled and reassembled onto the cable 5. To this effect, the net 12 comprises a longitudinal opening (not represented in the figures). This opening is, for example, formed by two contiguous elements 20 able to be selectively maintained in direct contact with each other along their entire length, for example by means of a bolt or an adhesive material. Thus, the net 12 may be formed from a rectangular piece of wire mesh which is wrapped longitudinally around the cable 5. Similarly, the device 14 is adapted to be detached from the net 12 and removed from the bridge 2.

To further facilitate the assembly of the system 4 on the cable and its disassembly from the cable, its construction may advantageously be modular. For example, sections or modules 20*D in length may be constructed with ends having connectors. This allows connecting successive sections to each other once they are mounted on the cable.

This also simplifies repairs in case of damage to a section or module during the service life of the system 4. It is easier to disconnect a faulty module and replace it with a new module, than to repair the entire device.

FIG. 4 represents another embodiment of a device for cleaning a surface. More specifically, FIG. 4 represents a boat 50 comprising a hull 52. The portion of the hull 52 which is immersed in water must be cleaned in order to limit the formation of a marine biofouling layer. For this purpose, the boat 50 includes a system 54 for cleaning a surface.

This system 54 comprises:
a surface 60 to be cleaned,
a net 62 for scraping the surface 60, and
a device 64 for moving the net 62, configured to move the net 62.

The surface 60 here is the outer face of the lower portion of the hull 52. This surface 60 is adapted to be fully immersed when sailing the boat 50. This surface 60 here has a complex shape comprising a combination of flat and curved surfaces (convex or concave).

The net 62 extends over the surface 60 and is capable of moving relative to the surface 60 while being guided relative to the surface 60. The net 62 here is bounded at its ends by an edge 66 which follows the periphery of the hull 52 of the ship. The net 62 here comprises:
filamentary elements 70, and
filamentary elements 72, pressed against the surface 60 and fixed to elements 70 to form a mesh.

These filamentary elements 70 and 72 are, for example, respectively identical to elements 20 and 22, except that they may have different dimensions and be made of different materials.

As before, the distance between two elements 70 is denoted d1, measured in direction Y and along element 72. Similarly, d2 denotes the distance between two elements 72, measured in direction X. Direction X extends from the front to the rear of the boat 50 and is tangent to the surface 60. Direction Y (not represented in FIG. 4) is perpendicular to direction X and is tangent to the surface 60. The characteristic dimension d1 of a mesh of the net is for example between T/2 and T/50, T being the draft of the vessel. Preferably, this dimension d1 is between T/5 and T/20. The characteristic dimension d2 of a mesh of the net is for example between L/10 and L/1000, L being the length of the vessel. Preferably, this dimension d2 is between L/50 and L/200.

The diameter of the filamentary elements 70, 72 is for example between 5 mm and 50 mm.

Net 62 and device 64 have the same function as net 12 and device 14 respectively. Similarly, their components have the same functions as those of net 12 and device 14. Also, what has been said in reference to the role and functions of net 12 and device 14 applies here and will not be repeated.

In this example, the elements 70 and 72 are made in two different ways. Indeed, here, the net 62 comprises preformed areas 74.

Such preformed areas 74 make it possible to adapt the curvature of the net 62 to the local curvature of the surface 60, particularly portions of the surface 60 which have a complex topology. For example, some portions of the surface 60 have local concave recesses.

It is thus unnecessary to use anchors to press the net 62 against the hull to keep the elements 72 in contact with the surface 60, as these anchors could damage the hull 60.

In each preformed area 74, the elements 70, 72 are made of a material of increased rigidity. Thus, these areas 74 can be preformed to have a shape complementary to that of the portion of the surface 60 on which they are to be positioned.

Outside these areas, the elements 70 and 72 are made of a flexible material capable of withstanding the tensile force exerted by the device 64. This material is, for example, formed of synthetic fibers of ultra-high-molecular-weight polyethylene such as the material known as “Dyneema.”

Joining elements ensure that the preformed areas 74 remain integrally secured to the rest of the net 62.

FIG. 5 shows details of another embodiment of the net 62, where the preformed areas 74 are eliminated. Here, each area 74 is replaced by a secondary anchor 80 configured to hold the net 62 pressed against the surface to be cleaned.

For example, this secondary anchor 80 comprises a filamentary element 91 extending between two ends 92 and 94. This element 91 is fixed by end 92 to the surface to be cleaned and by end 94 to the net 62. For example, the end 94 comprises a loop enclosing an element 70 and another element 72 at the point where they join. The anchor may be mechanical, magnetic, or adhesive.

This ensures that the net 62 is pressed against the surface 60 when said surface has significant curvature and it is possible to create anchors by drilling or gluing on the surface 60.

In the previous two embodiments, magnetic attractive forces can be harnessed for better guidance of the net relative to the surface to be cleaned. For example, by placing a magnetic net on the steel hull of a boat 50 where the hull comprises magnetic metal material, the magnetic attractive forces will help keep the net pressed against the surface and guide it during its movements.

Note that this magnetic guidance is different in nature from the magnetic anchoring mentioned above; in the case of magnetic anchoring, the aim is to prevent any movement or displacement of the anchor via a sufficiently strong magnetic force, whereas in the case of the magnetic guidance the magnetic attractive forces hold the net on the surface without preventing movement relative to the surface.

In cases where the geometry of the hull is very simple, the magnetic guidance may be sufficient in itself as means for holding and guiding the net on the surface of the hull.

This magnetic guidance solution may also be used in the case of non-metal hulls, such as composite hulls for example:
by applying a paint containing iron/steel particles to the hull;
   by incorporating iron/steel particles into the composition of the composite during manufacture of the composite hull;
by applying a thin steel film on the inner or outer surface of the composite hull.

As for the system 4, if there are protuberances on the hull such as hydrodynamic protrusions for example, the net 62 has appropriate openings in line with these protrusions. Thus, the net 62 can travel back and forth without impediment, as the dedicated openings move around the protrusions while encircling them.

FIG. 6 represents the device 64 in more detail. The device 64 here comprises:
an actuator 76 fixed at a front end 67 of the net 62,
a drive cable 84,
an anchor line 86,
a control module 88.

The actuator 76 is configured to exert a pulling movement along direction X in a particular direction of travel.

The device 64 is here attached to the end 67 of the net 62 and to the boat 50. For this purpose, here each actuator 76 of the device 64 is placed on the taut line 86 anchored to the deck of the boat 50. This line 86 here follows the contour of the surface 60. Actuator 76 is, for example, an actuator identical to actuator 30, except that its driving characteristics are adapted for moving net 62.

Again, as with system 4, in order to facilitate assembly and disassembly of the device 64 on the hull, the construction of the net 62 may advantageously be modular. For example, net sub-surfaces may be constructed with ends having connectors. This allows connecting them to each other when installing the device 64 on the surface 60 in stages. Temporary attachment means hold the net sub-surfaces on the hull, before the entire assembly is attached and traction is applied.

This also simplifies repair in case of damage to a net sub-surface during the service life of the device 64.

FIG. 7 shows another embodiment of a device for cleaning a surface. More specifically, FIG. 6 represents a pipe 100 for conveying a fluid, such as hydrocarbons. For example, this pipe 100 is a pipeline used for the extraction of hydrocarbons. This pipe 100 has an inner surface 102 needing to be cleaned in order to limit the formation of a deposit (such as hydrate crystals). For this purpose, the pipe 100 comprises a system 104 for cleaning the surface 102.

This system 104 comprises:
the surface 102 to be cleaned,
a net 110 for scraping the surface 102, and
a device 114 for moving the net 110, configured to move the net 110.

The surface 102 here is the inner face of a hollow cylindrical shape.

Here, the pipe 100 extends longitudinally along a line X′ having straight segments and possibly curves. The net 110 extends here over the surface 102 and is able to move relative to this surface 102 while being guided with respect to this surface 102 along this direction X′.

The net 110 here comprises:
filamentary elements 120, and
   filamentary elements 122, pressed against the surface 102 and attached to elements 120 to form a mesh.

To simplify FIG. 5, the elements 120 and 122 are drawn with dotted lines. In addition, only two elements 120 are represented.

Here again, net 110 and device 112 play the same respective roles as net 12 and device 14. Similarly, their components have the same role as those of net 12 and device 14. Also, what has been said with reference to the role of net 12 and device 14 applies again here and will not be repeated.

Elements 120 are configured to withstand the pulling force of elements 122. Elements 120 are for example identical to elements 20.

Here, elements 122 are identical to elements 22. Elements 122 have a diameter greater than the inside diameter of the pipe 100 when they are at rest. An element 122 is said to be at rest when it is not pressed against a surface such as the surface 102. In addition, here each element 122 is resiliently deformed when pressed against the surface 102. Its pressure against the surface 102 is thus increased, which increases cleaning efficiency. The pressure is, however, optimized to ensure proper guidance of the net on the surface while minimizing resistance to the movement of the net over the surface to be cleaned.

This biasing pressure allows the net 110 to match the geometry of the pipe, particularly in the curved portions of the pipe (portions having a longitudinal curvature).

The minimum distance between two consecutive elements 122 is for example between D/2 and 10*D, D being the inside diameter of the pipe 100. Here, the pipe 100 has a circular cross-section of an inside diameter greater than or equal to 0.2 m or 1 m. Here elements 122 are evenly distributed along the pipe 100 and are separated from each other by a distance d2′. This distance d2′ is, for example, greater than twenty meters here.

The device 114 here comprises:
a plurality of movable elements 130 configured to move the net 110 along direction X′ in a reciprocating movement;
a control unit 132 configured to control the actuators 130.

FIG. 8 shows an example element 130 in more detail. Elements 130 are connected to elements 120 so that the movement of element 130 along direction X′ causes movement of elements 122 along this same direction X′. For this purpose, elements 130 are preferably pressing against the inner surface of the pipe 100, to produce a scraping force in the longitudinal direction X. In other words, elements 130 also act as movable anchors for the net 110.

Here, the device 114 comprises two elements 130, each placed at one of the two opposite ends of the net 110. The distance, measured in direction X′, between two consecutive elements 130 here is between 10*D and 1000*D, D being the inside diameter of the pipe 100. Preferably, this distance is between 50*D and 500*D.

These elements 130 here are rigid rings made of metal and have a width, measured in direction X′, that is greater than or equal to 5 cm or 50 cm. The outer diameter of elements 130 is here equal to that of elements 122. As indicated above, element 130 is preferably pressing against the surface 102 in order to generate the required internal forces in the net 110. For this purpose, element 130 may be biased via circumferential actuators pressing it against the surface 102 with a given radial pressure.

Each element 130 here comprises a plurality of actuators 134, which here are incorporated into the elements 130. These actuators 134 may be flexible rollers or wheels. For example, each actuator 134 is able to move in translation relative to the inner wall of the pipe 100 in response to a control signal sent by the module 132 and received by the actuator 134. The actuators 134 are here configured to generate a movement of element 130 in either direction along direction X′.

The actuators 134 of each element 130 are here synchronized with each other so that element 130 progresses uniformly when moved by the actuators 134. Similarly, here, the respective actuators 134 of elements 130 are also synchronized with each other so that the net 110 and hence the second elements 122 move uniformly along direction X′ inside the pipe 100 when elements 130 are moving. In addition, this synchronization is performed so as to generate sufficient tension in the net 110 and in the elements 122, in order to achieve a sufficiently strong scraping of the inner surface of the pipe 100. To this end, each actuator 134 is here configured to transmit to the module 132 information concerning the position of the element 130 to which it belongs as well as the value of the tension in the net 110 at its location.

The system 104 comprises at least three elements 120. However, in the interests of clarity, only two elements 120 are shown in FIG. 6. These elements 120 are preferably uniformly distributed around elements 122 and 130. Advantageously, one of the elements 120 comprises a power supply line for the actuators 134, configured to supply electricity to the actuators 134. The system 114 also comprises a data bus configured to carry the control signals sent by the module 132 to the actuators 134. For example, these control signals are sent on the power supply line by means of power-line carrier techniques. For this purpose, the element 120 that comprises the power supply line is electrically connected to the module 132. The module 132 here is located outside the pipe 100.

Here, element 130 also acts as a scraper element for cleaning the surface 102.

In this example, element 130 has a hydrodynamic shape configured to minimize resistance to the flow of a fluid within the pipe 100. FIG. 9 shows an example of this shape in more detail. For example, the cross-section of element 130 has a lenticular shape and comprises:
a flat face 150, adapted to be kept in contact with the surface 102 in order to scrape the surface 102, and
a rounded face 152 having a convex shape, on the opposite side from face 150. Face 152 here is turned towards the inside of the pipe 100 so as to be in contact with the fluid circulating within the pipe 100. The convex shape thus facilitates the flow of fluid.

The system 104 here is detachable, meaning it can be installed in the pipe 100 and removed from the pipe 100 for subsequent reuse. For example, the system 104 is installed as follows: first by attaching the net 110 to the elements 130, then inserting an element 130 located at one end of the net 110, then actuating the actuators 134 of this element 130 so that it is moved within the pipe 100 while being in contact with the surface 102. The operation is then repeated in turn for the other elements 130 and nets 110 of the system 104.

An example of using the system 4 to clean the surface 10 will now be described with reference to the flowchart in FIG. 10 and to FIGS. 1 to 3.

In step 200, the net 12 is affixed to the surface 10.

Then, during step 202, the net 12 is tensioned and positioned on the surface 10. Preferably, the net 12 is pressed against the surface 10.

Then, during step 204, the net 12 is moved relative to the surface 10 in a reciprocating movement so as to scrape the surface 10 to clean it.

Many other embodiments are possible.

For example, the system 4 can be used to clean the outer surface of a support cable or drive cable of an aerial lift system such as an aerial tramway, a chairlift, or a gondola. In this case the net 12 can be modified, in particular by replacing the elements 22 with rigid metal rings.

The system 4 may also be used to clean the outer surface of a power line, in order to reduce frost formation on the power line. In this case, the rings 24a, 26a and the cables 24b, 26b may comprise electrical insulators.

The system 4 may also be used to clean the tubular structure of an oil rig or the outer surface of a marine cable such as those of a seismic streamer (towed array) for example, to prevent accretion of marine organisms such as barnacles for example.

The net 12 may be made of another material, for example a textile material.

The device 14 may be different. For example, actuator 30 is adapted to move the net 12 intermittently along direction X in a direction of movement. Actuator 32 is then replaced by a resilient anchor line, adapted to exert on the net 12 a restoring force in a direction opposite the direction of movement exerted by the actuator 30. The module 34 is then modified accordingly.

Alternatively, to ensure the movement along direction X, actuators 30 and/or 32 comprise a rack, or hydraulic cylinders, or a worm rotation mechanism.

Elements 20 and 22 may extend in directions other than directions X and Y.

The mesh of the net may have another shape. For example, the elements 20 and 22 are arranged so that the mesh has the shape of a triangle, rhombus, or polygon with five or six sides.

Alternatively, the device 14 is further configured to trigger movement of the net 12 when climatic conditions conducive to formation of a soiling deposit on the surface 10 are detected. For this purpose, the device 14 comprises an analysis unit configured for:
measuring physical data of the environment of the system 4, such as weather conditions,
calculating the probability of formation of soiling deposits on the surface 10 based on the measured physical data.

The device 14 is then configured to control the starting or stopping of the system 4 and the speed and/or the frequency of movement of the net 12 according to the calculated probability of deposits. For example, the analysis unit comprises a weather station, included in the module 34, configured for measuring atmospheric conditions and for issuing a control signal when the probability of frost formation, determined from the measured atmospheric conditions, exceeds a predefined threshold value. The weather station here comprises temperature, wind speed, and/or humidity sensors for this purpose.

The device 14 may also include a unit for measuring the thickness of soiling on the surface 10, for example comprised in the module 34. The device 14 is then configured to control the starting or stopping of the system 4 and to adapt the speed and/or frequency of movement of the net 12 based on the data measured by said measuring unit. For example, if the thickness of said soiling, measured a certain period of time after the net 12 has traveled the entire surface 10, exceeds a predetermined thickness, then the frequency of movement of the net 12 is increased. Thus, the measurement result from this unit allows modifying the program for actuating the scraping system to adapt it to the soiling deposition rate in order to reduce the thickness of the soiling between each passage of the second filamentary elements. This measuring unit includes, for example, optical sensors.

Alternatively, the system 54 may be used to clean one or more external surfaces of a structure, a piece of equipment, a machine, or a vehicle, prone to deposits. These deposits may be snow and/or ice, dust and other dirt, or rust, or come from biological organisms (biofouling) or from minerals such as scale deposit (tartar) or salt, for example.

Thus, system 54 can be used to clean a turbine blade or the fuselage and wings of an aircraft in order to limit the formation of snow, frost, or ice deposits. System 54 may also be used to facilitate clearing the accumulated snow from a surface such as the roof of a building, a hangar, or a sports stadium. In these cases, the net 62 may be made differently, in particular of another material.

System 54 may also be used for continuous cleaning of solar panels, solar thermal collectors, or solar mirrors. Here, additional means such as foam or fine brushes may be attached or connected to the scraping net (62) to enhance the cleaning of the surface to be cleaned.

Similarly, device 64 may be different, for example comprising actuators arranged along the entire periphery of system 54 in order to create movement of the scraping net 62 with more complex kinematics than a simple reciprocating movement.

The actuators may be located in the net surface and not on its periphery. In addition, the actuators may always be in place or may be put in place from time to time for temporary use.

Furthermore, internal differential movements may be induced in the scraping net. This can be useful in the case of resistant deposits, such as ice for example. Differential movements induced between the filamentary elements of the net allow generating shear forces to help break up the resistant deposited layer.

Advantageously, system 54 comprises a passive actuator with hydrodynamic energy recovery. For example, the net 62 is formed such that it can be set in motion by a flow of fluid along the surface 60, even when the device 64 is not activated. The surface 60 is thus cleaned more frequently.

Elements 70, 72 may be made of a different material, such as carbon fibers.

The preformed areas 74 may be omitted. These areas 74 may be replaced by anchors fixed on the surface 60.

Module 64 may comprise more than one actuator 76. Module 64 may also comprise one or more additional actuators, which are identical to actuator 76 but are placed at the rear of the vessel. These additional actuators are thus configured to cause a movement of the net 62 along direction X but in a direction of movement opposite to that of actuator 76 so that they alternate in operation with actuator 76 to generate the reciprocating movement of the net 62.

Several instances of system 104 may be placed at different positions in the pipe 100. These instances of system 104 may then operate independently.

Device 114 may be implemented differently. The data bus of device 114 may include a radio link such as a WiFi connection.

Elements 120 and/or 122 may be made of another material.

Elements 130 may be made differently. For example, the actuators 134 are replaced by winches capable of moving elements 120 in translation in order to move the net 110. In this case, elements 130 may be anchored to the pipe 100, for example in sections specifically provided for this purpose along the pipe.

Elements 130 may not have any actuators 134. Actuators 134 may then be located on the outer circumference of the pipe 100. In this case, these actuators 134 are configured to move elements 130, for example by exerting an electromagnetic force through the pipe 100. In one embodiment, each actuator 134 comprises an armature and an inductor. The armature is located inside and the inductor is located outside the pipe 100.

In a variant for short pipes, the kinematics of the cleaning can be rotational. In this case, elements 130 have actuators producing a circumferential rotation of the net 110. In this case, elements 120 are scrapers and the entire net is pressed against the inner wall of the tube to be cleaned.

System 54 may also be used to clean one or more internal surfaces of a structure, a piece of equipment, a device, or a machine prone to deposits. These internal surfaces may be walls or the surface of internal elements of such systems. Deposits may result from, for example, biological organisms (biofouling), organic matter, minerals such as scale or salt, hydrates or paraffin, soot, ash, slag or carbonaceous residues, or rust.

For example, the corrugations of plate heat exchangers, prone to deposits of various kinds, can be cleaned with a net integrated with the surface of each plate. The programmed movements and vibrations of the net allow eliminating initial deposits and thus preventing the initiation and accumulation of deposits on the plates.

Alternatively, in cases where the distance between the successive plates of the heat exchanger is small, a single net may be installed between each set of two successive plates. This net can thus clean the two closely spaced surfaces which the fluid or gas flows between via vibratory movements.

System 54 may also be used for cleaning the internal surfaces of industrial boilers, such as coal-fired boilers for example, which are prone to deposits of soot, ash, slag, or carbonaceous residues.

System 54 may also be used for cleaning the internal surfaces of combustion engines. One example is the cleaning of exhaust gas recirculation systems in diesel engines, which are subject to soot deposits.

Steps 200, 202, and 204 may also be applied with systems 54 or 104.

1-25. (canceled)

26. A system for cleaning a surface that extends in an axial direction and in a transverse direction perpendicular to the axial direction, the system comprising
a scraping net that comprises:
first filamentary elements extending in a first direction and which are spaced apart from one another in a second direction that is different from the first direction,
second filamentary elements extending in the second direction and spaced apart from one another in the first direction, said second filamentary elements being fixed to the first filamentary elements so as to form a mesh;
a net movement device configured to move the scraping net in a reciprocating movement parallel to the first direction and with an amplitude of movement at least equal to an average distance between the second filamentary elements.

27. The system according to claim 26, wherein the net movement device is configured to move the scraping net with an amplitude of movement that is less than or equal to three times the average distance between the second filamentary elements.

28. The system according to claim 26, wherein the net movement device comprises an actuator adapted to set the scraping net in motion in response to a control signal.

29. The system according to claim 26, further comprising:
guiding elements for guiding the scraping net in a mounted configuration with respect to the surface to be cleaned, the scraping net being guided with respect to the surface to be cleaned in the mounted configuration so that the scraping net fits against the surface to be cleaned and the first direction is maintained collinear with the axial direction of the surface to be cleaned when the scraping net is moved according to the reciprocating movement.

30. The system according to claim 29, wherein the second filamentary elements have each a non-zero curvature and are part of the guiding elements.

31. The system according to claim 29, comprising the surface to be cleaned, wherein the second direction is collinear with the transverse direction of the surface to be cleaned.

32. The system according to claim 31, wherein the scraping net extends between two opposite axial ends,
and wherein the net movement device comprises:
an actuator adapted to set the scraping net in motion in response to a control signal, the actuator attached to one of the two axial ends of the scraping net, the actuator being configured to exert a pulling movement along the axial direction in a first direction of movement;
a resilient anchor, attaching the other of the two axial ends of the scraping net relative to the surface to be cleaned, exerting a restoring force on the scraping net in a second direction of movement opposite to the first;
a control module programmed to successively actuate the actuator in order to move the scraping net in said reciprocating movement.

33. The system according to claim 31, wherein the net movement device comprises:
two actuators;
a control module programmed to actuate, successively and alternately, one or the other of the two actuators in order to move the scraping net in said reciprocating movement.

34. The system according to claim 31, wherein the scraping net extends between two opposite axial ends and the two actuators comprise:
a first actuator, fixed to one of the two axial ends of the scraping net, the first actuator being further configured to exert a pulling movement along the axial direction in a first direction of movement;
a second actuator attached to the other of the two axial ends of the scraping net, the second actuator being further configured to exert a pulling movement along the axial direction in a second direction of movement.

35. The system according to claim 31, wherein the net movement device comprises at least one actuator adapted to set the scraping net in motion in response to a control signal, and wherein the net movement device:
comprises a measuring unit configured to measure thickness of soiling deposits on the surface to be cleaned;
is configured to control the starting or stopping of said at least one actuator as well as a speed and/or a frequency of movement of the scraping net based on data provided by said measuring unit.

36. The system according to claim 31, wherein the net movement device comprises at least one actuator adapted to set the scraping net in motion in response to a control signal, and wherein the net movement device:
comprises an analysis unit configured for:
measuring physical data of environment of the system, and
calculating a probability of formation of soiling deposits on the surface to be cleaned, based on the measured physical data;
is configured to control the starting or stopping of said at least one actuator as well as a speed and/or a frequency of movement of the scraping net based on the calculated probability of deposits.

37. The system according to claim 31, wherein the net movement device comprises at least one actuator adapted to set the scraping net in motion in response to a control signal, and wherein said at least one actuator comprises a winch.

38. The system according to claim 31, wherein the net movement device comprises a passive actuator with energy recovery, configured to move the scraping net in response to a flow of fluid along the surface to be cleaned.

39. The system according to claim 31, wherein the second filamentary element has an elastic stiffness and a geometry at rest such that it is adapted to be deformed by traction and then released to press against the surface to be cleaned, so that the scraping net is guided relative to the surface to be cleaned by means of resilient contact forces resulting from this pressure.

40. The system according to claim 31, wherein the second filamentary element has an elastic stiffness and a geometry at rest such that it is adapted to be deformed by compression and then released to press against the surface to be cleaned, so that the scraping net is guided relative to the surface to be cleaned by means of resilient contact forces resulting from this pressure.

41. The system according to claim 30, further comprising a third filamentary element having two ends and fixed by one of the two ends to the scraping net and by the other of the two ends to the surface to be cleaned, the third filamentary element being part of the guiding elements.

42. The system according to claim 40, wherein the third filamentary element is provided with a removable attachment end configured to form a determined anchor chosen amongst the group of the mechanical, magnetic and adhesive anchors, so that the third filamentary element can be attached to the surface to be cleaned in a removable manner.

43. The system according to claim 31, wherein the scraping net is pressed against the surface to be cleaned through magnetic or electromagnetic attractive forces, so that the scraping net is guided on the surface to be cleaned by means of these attractive forces.

44. The system according to claim 31, wherein:
the surface to be cleaned comprises local protrusions;
the scraping net comprises dedicated openings traversed by these protrusions.

45. The system according to claim 26, wherein the first and second filamentary elements of the scraping net are interconnected via mechanical connection means.

46. The system according to claim 26, wherein the scraping net is of modular construction, the different modules being fixed together by mechanical connection means.

47. The system according to claim 26, wherein additional means are attached or connected to the scraping net in order to facilitate scraping and cleaning the surface to be cleaned by said net.

48. The system according to claim 31, wherein the surface to be cleaned defines a total surface area, a cumulative surface area defined by all the portions of the surface to be cleaned which are in contact with the second filamentary elements being less than or equal to 5% of the total surface area of the surface to be cleaned.

49. The system according to claim 31, wherein the scraping net comprises preformed areas of a material of increased rigidity as compared to other areas of the scraping net, each of the preformed areas being positioned on a determined surface portion of the surface to be cleaned and having a shape complementary to that of said determined surface portion, the surface to be cleaned being at least partly curved and the second filamentary element having a curved contact surface which fits against the surface to be cleaned.

50. A system for cleaning a tubular surface that extends in a longitudinal direction, the system comprising:
a scraping net that comprises:
first filamentary elements extending in a first direction and which are spaced apart from one another in a second direction that is different from the first direction,
second filamentary elements extending in the second direction and spaced apart from one another in the first direction, said second filamentary elements being fixed to the first filamentary elements so as to form a mesh;
a net movement device configured to move the scraping net in a reciprocating movement parallel to the first direction and with an amplitude of movement at least equal to an average distance between the second filamentary elements; and
guiding elements that are annularly shaped for orientating the scraping net in a mounted configuration with respect to the tubular surface to be cleaned, so that the first direction is maintained collinear with the longitudinal direction of the tubular surface.

51. A system for cleaning a non-planar surface that extends in an axial direction and in a transverse direction perpendicular to the axial direction, the system comprising:
a scraping net that comprises:
first filamentary elements extending in a first direction and which are spaced apart from one another in a second direction that is different from the first direction,
second filamentary elements extending in the second direction and spaced apart from one another in the first direction, said second filamentary elements being fixed to the first filamentary elements so as to form a mesh;
a net movement device configured to move the scraping net in a reciprocating movement parallel to the first direction and with an amplitude of movement at least equal to an average distance between the second filamentary elements; and
guiding elements for orientating the scraping net in a mounted configuration with respect to the non-planar surface to be cleaned, the scraping net being guided with respect to the non-planar surface to be cleaned in the mounted configuration so that the first direction is maintained collinear with the axial direction of the non-planar surface to be cleaned when the scraping net is moved according to the reciprocating movement; wherein the guiding elements comprises preformed areas that belong to the scraping net.
